(19) United States
(12) Patent Application Publication
(10) Pub. No.: US 2003/0042751 A1
(43) Pub. Date: Mar. 6, 2003

(54) Removable motor vehicle roof for a convertible

(75) Inventor: Michael Antreich, Germering (DE)

Correspondence Address: NIXON PEABODY, LLP, 8180 GREENSBORO DRIVE, SUITE 800, MCLEAN, VA, 22102, US

(73) Assignee: Webasto Vehicle Systems International GmbH, Stockdorf (DE)

(21) Appl. No.: 10/194,995

(22) Filed: Jul. 15, 2002

(30) Foreign Application Priority Data
Jul. 17, 2001 (DE) 101 33 957.7

(51) Int. Cl. B60J 7/00

(52) U.S. Cl. 296/107.17

(57) ABSTRACT

A motor vehicle roof for a convertible motor vehicle, and a convertible motor vehicle with such a roof, is provided which includes a front roof part arrangement and a rear roof part which can be moved between a closed position which covers the motor vehicle interior and a removed position which exposes the motor vehicle interior in a rear roof storage space. The front roof part arrangement is pivotally supported on the motor vehicle by a multiple-bar arrangement. To improve utility, the rear roof part is movably supported by a bearing means on the motor vehicle body which permits movement of the rear roof part when the front roof part arrangement is being removed into an upper position. The rear roof part covers the removed front roof part arrangement in an identically pointed alignment when in a lower removed position.

### BACKGROUND OF THE INVENTION

1. Technical Field

The present invention relates to a motor vehicle roof for a convertible with a front roof part arrangement and a rear roof part which can be moved between a closed position which covers the motor vehicle interior and a removed position which exposes the motor vehicle interior in a rear roof storage space wherein the front roof part arrangement is pivotally supported on the motor vehicle by a multiple-bar arrangement.

2. Description of Related Art

German Patent 199 34 673 C1 discloses a generic motor vehicle roof in which the middle roof part is supported by a main four-bar mechanism on the motor vehicle, the front roof part is supported by a four-bar mechanism on the middle roof part and the rear roof part is attached to the rear main connecting rod of the main four-bar mechanism and can be swiveled with it. When the motor vehicle roof is swiveling, all roof parts are guided by forced motion. The roof parts are deposited in the trunk of the motor vehicle on top of one another such that the rear roof part with its bottom points up, while above it the front roof part, in an identically cambered position, is deposited over the middle roof part so that the tops point up. A trunk lid covers the removed roof parts and may be swiveled to the rear for depositing the motor vehicle roof. Due to the forced motion of all roof parts, however, no partially open positions can be set. Since the rear roof part is deposited cambered opposite to the two front roof parts, a stowage space which is higher in the vertical direction is needed in the trunk.

Published German Patent Application 197 52 068 A1 discloses a roof structure for passenger cars which has an at least one-part front roof element pivotally coupled to opposite lateral roof supports and moveable from its closed position via intermediate positions to the rear into a rear receiving space. The rear roof element is supported on its rear edge to be able to swivel on the body around a transverse axis and can be folded up for removing the front roof element. When the front roof element has assumed its removed position, the rear roof element swivels back again and covers the front roof element. The front roof element contains lateral roof supports on which it is coupled to the body and which are connected to one another to form a roll bar so that in the removed position of the front roof element the roll bar has been swiveled up into its operating position. The rear roof element can be further lowered out of its closed position so that a completely open vehicle is formed. The fixed swiveling axis for the front roof element however limits the freedom of configuration in the layout of the roof. The oppositely-cambered deposition of the front roof element and the rear roof element is also disadvantageous.

### SUMMARY OF THE INVENTION

One object of the present invention is to overcome the disadvantages of the conventional roof systems and to provide an improved structure for adjusting various roof positions, and a convertible with one such roof.

This object, and other objects, are achieved by providing a motor vehicle roof having a rear roof part that is movably supported by a bearing means on the body, wherein the bearing means permits movement of the rear roof part when the front roof part arrangement is being removed into an upper position. The rear roof part covers the removed front roof part arrangement in an identically pointed alignment when in a lower removed position. Due to the multiple-bar arrangement, the front, one-part or multi-part, roof arrangement can be moved in a swiveling motion into the roof storage space such that the rear roof part, which can be moved up and down and which is supported on the body, is deposited in the identically cambered position on the front roof part arrangement so that less stowage space in the roof storage space is needed in the vertical direction. In its lower position, the rear roof part covers the removed front roof part arrangement such that no additional cover for the convertible top compartment is necessary.

The front roof part arrangement can have one or more roof parts, for example a front roof part and a middle roof part, which are placed on top of one another with the same camber when deposited in the roof storage space. The front roof part can additionally be divided into several roof elements which are deposited together. The front roof parts can be formed either as hardtop parts or as a frame with soft top covering.

In one simple configuration, the rear roof part is supported for swiveling around a rear, vehicle-mounted transverse axle so that it executes a simple swiveling motion when its front edge is raised and lowered. To execute the swiveling motion, the rear roof part can be pivotally supported on the body by means of a swiveling joint or also by a connecting rod means.

One preferred embodiment includes the rear roof part being positioned set back by the bearing means or the connecting rod means in its lower deposited position in the roof storage space relative to its closed position, so that a stationary swiveling axis is not formed. While in a swiveling motion of the rear roof part around a stationary transverse swiveling axis, the rear roof part must also be located in the closed position behind the vehicle seats, in order to be able to be swiveled down into the roof storage space. By backward positioning, the roof part can be located in its closed position over the seat. In this way, there arise diverse possibilities for the structural layout of the roof for both two-seat and four-seat convertibles. In this case, it can also be feasible to arrange a rear, pivotally supported roof cover flap which can be raised with its front edge behind the rear roof part in order to cover the top opening of the roof storage space. The roof cover flap is opened and raised when the rear roof part is raised and lowered. The roof cover flap can be a trunk lid, which if necessary can be swiveled around its front edge or its rear edge. Alternatively, the roof cover flap is an additional flap which is supported on the trunk lid or on the body.

A bearing means for the front roof part is preferably a four-bar mechanism which is supported on the middle roof part. The middle roof part is preferably supported to be able to move by means of the four-bar mechanism on the body, for example there being one four-bar mechanism on each of the two sides of the vehicle.

To control movement when the roof is being removed, it is feasible for the front roof part to be forcibly moved by means of a coupling rod connected to the bearing means of the middle roof part. But there can also be independent drives. Thus the front and the middle roof parts as well as the rear roof part can each have its own drive, such as a piston-cylinder drive.

Furthermore, in addition to the arrangement in its lower removed position, the rear roof part can be positionable in a protective position as a roll bar when the front and middle roof parts have been removed. This protective position is, for example, the closed position of the rear roof part, and forms a partial open position of the motor vehicle roof.

A convertible in accordance with the present invention contains a motor vehicle roof preferably having a rear, pivotally supported roof cover flap which can be raised with its front edge behind the rear roof part as the transition to the trunk cover. The roof cover flap, depending on the configuration of the roof and vehicle rear, can be designed to cover the top opening of the roof storage space which can be necessary in a corresponding removal motion of the rear roof part. The roof cover flap can be a trunk lid or an additional flap which is supported on the trunk lid or the body.

### BRIEF DESCRIPTION OF THE DRAWINGS

FIG. 1 shows a side, partial schematic view of a convertible of the present invention with a hardtop vehicle roof with a front, a middle and a rear roof part in the closed position;

FIGS. 2-6 each show a side schematic view of the hardtop vehicle roof with the front and middle roof part moved into different positions;

FIG. 7 shows in a side view in a schematic the hardtop vehicle roof in the removed position with the rear roof part lowered;

FIG. 8 shows a side partial schematic view of the convertible with a second embodiment of a hardtop vehicle roof, only its rear roof part being shown in the closed position; and

FIGS. 9-13 show the convertible of FIG. 8 with the rear roof part of the hardtop vehicle roof when transferred out of the closed position into the removed position.

### DETAILED DESCRIPTION OF THE PREFERRED EMBODIMENTS

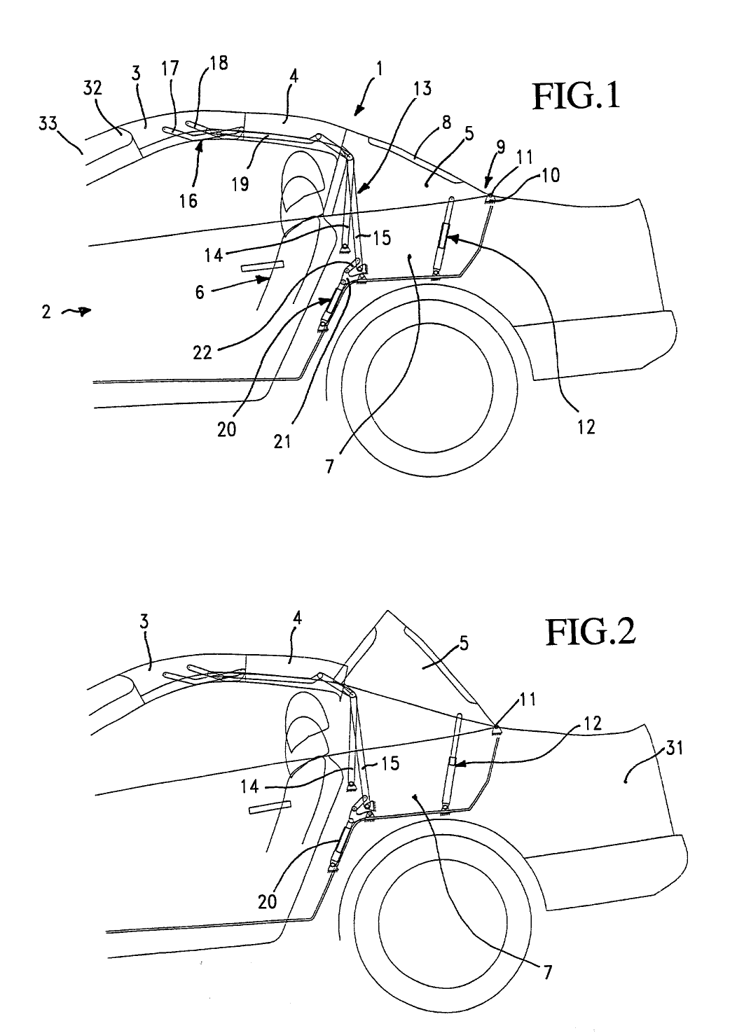

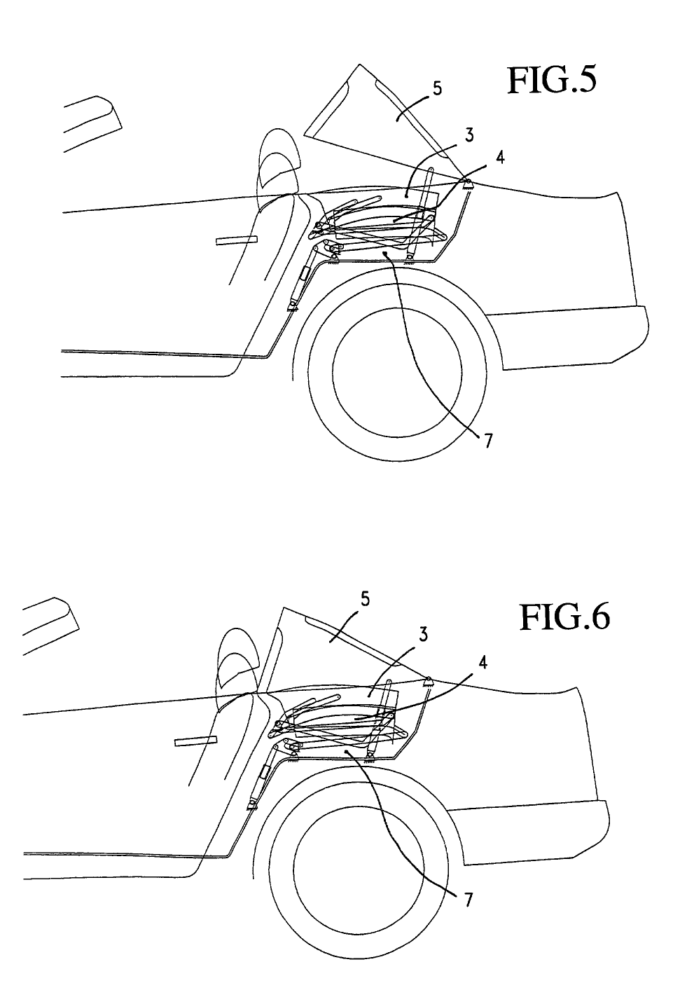

The motor vehicle roof 1 of the present invention for a convertible motor vehicle 2 is made as a hardtop which can be opened (see FIGS. 1-7) and has a front roof part 3, a middle roof part 4 and a rear roof part 5. The convertible 2 is shown as a two-seat vehicle with one row 6 of seats, but can also have two rows of seats with the roof parts of the motor vehicle roof 1 being made accordingly longer. When the motor vehicle roof 1 is opened and removed, the front roof part 3 and the middle roof part 4 are deposited in a convertible top compartment or roof storage space 7 behind the row 6 of seats in the rear area of the convertible 2.

The rear roof part 5, which contains a rear window 8, is supported on its rear edge 9 by a bearing means 10 which permits the rear roof part 5 to swivel around a vehicle-mounted transverse swiveling axis 11. The rear roof part 5 can be swiveled via a raising means, for example a hydraulic piston-cylinder unit 12 supported on the body of the convertible motor vehicle.

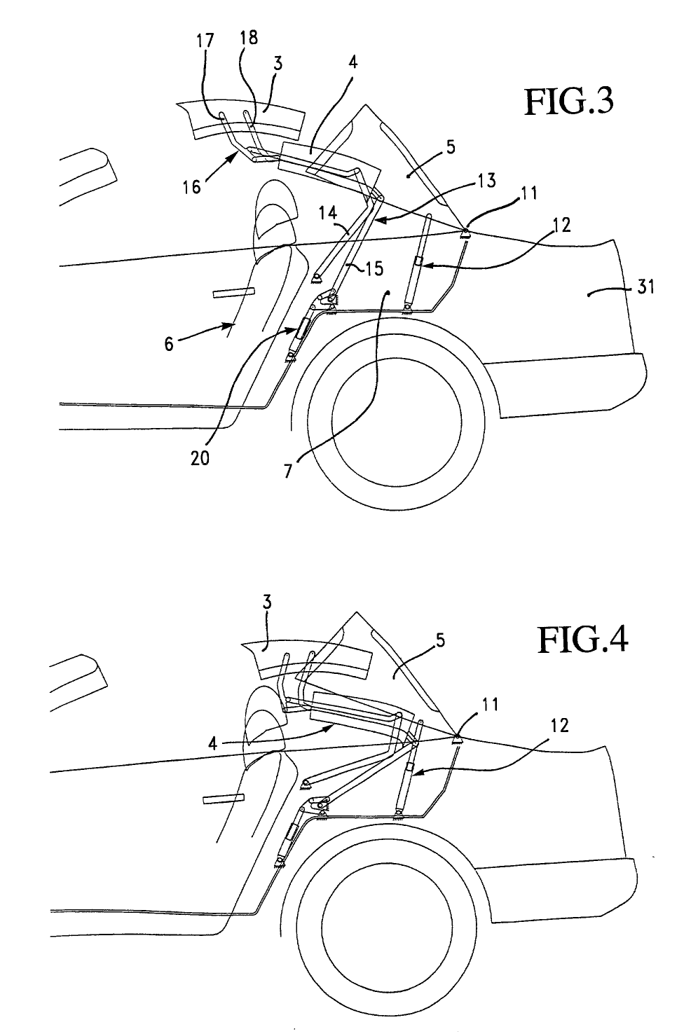

The middle roof part 4 is movably supported on the body on each side of the convertible 2 by means of a main four-bar mechanism 13 which has a front main connecting rod 14 and a rear main connecting rod 15. The front roof part 3 is movably supported on the middle roof part 4 on each side of the convertible 2 by means of a front four-bar mechanism 16 which has a front connecting rod 17 and a rear connecting rod 18. A coupling rod 19 (FIG. 1) kinematically couples the front main connecting rod 14 of the main four-bar mechanism 13 to the front connecting rod 17 such that the swiveling motion of the main four-bar mechanism 13 forcibly swivels the front roof part 3 onto the middle roof part 4 into the removed position (see FIGS. 3-5). A drive means for the middle roof part 4 contains, for example, a hydraulic piston-cylinder unit 20 which has gearing with a swiveling connecting rod 21 and an intermediate lever 22 coupled to the rear main connecting rod 15 of the main four-bar mechanism 13.

To open and remove the motor vehicle roof 1, first the rear roof part 5 (FIG. 2) with its front edge is swiveled around the rear transverse swiveling axis 11 into its upper position, by which the removal path for the front roof part 3 and the rear roof part 4 is cleared. After the front roof part 3 has been decoupled from a cowl 32 above the windshield 33, the drive means 20 swivels the main four-bar mechanism 13 and thus the middle roof part 4 to the rear. The front roof part 3 is entrained via the front four-bar mechanism 16, which is swiveled by means of the coupling rod 19, and the two roof parts 3 and 4 are transferred into the roof storage space 7 and thus deposited in an identically cambered position, i.e. with the camber facing the same direction and tops pointing upward (see FIGS. 3, 4 and 5). Then the piston-cylinder unit 12 lowers the rear roof part 5 again into its original closed position (FIG. 6). In this way partial opening of the motor vehicle roof 1 is set, in which the rear roof part 5 is used as a wind deflector and at the same time as a stable roll bar due to the secure support on the body.

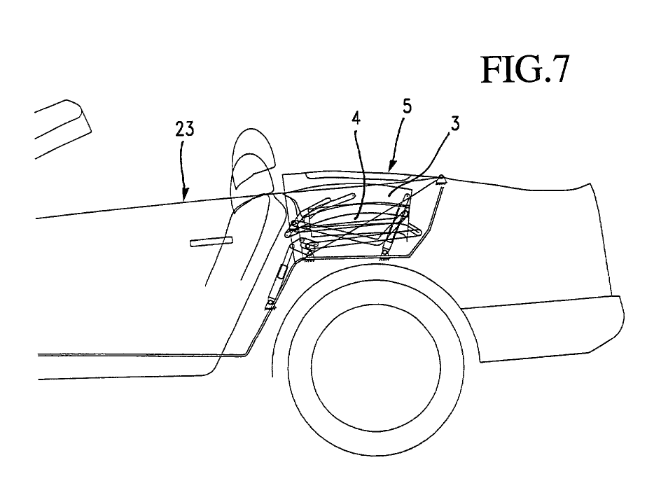

The removed position for the completely opened hardtop vehicle roof 1 is set by the rear roof part 5 being lowered with its forward edge in addition until it assumes a flat position which extends roughly up to the height of the equator line 23 of the convertible 2 (FIG. 7). In this lower removed position, the rear roof part 5 is likewise identically cambered to the two underlying roof parts 3 and 4 and forms their cover. Thus, an additional cover for covering the removed roof parts is not necessary. Lateral cover flaps (not shown) can be movably supported on the body in order to seal the removed rear roof part 5 toward the lateral body sections or at least to form a planar transition if required by the shape of the rear roof part 5.

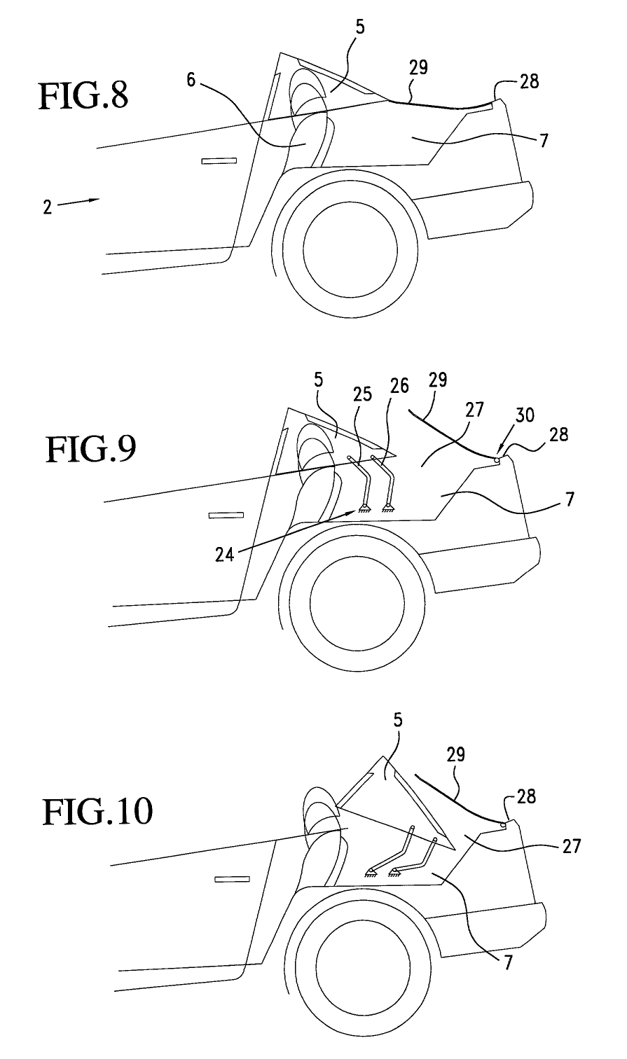

A second embodiment of the hardtop vehicle roof of the present invention contains a front and a middle roof part which are supported and configured according to the aforementioned embodiment and can be removed accordingly (these two roof parts are not shown in FIGS. 8-13). The rear roof part 5 is movably supported via a bearing means 24 on the body, for example on either side by means of the respective four-bar mechanism with a front connecting rod 25 and a rear connecting rod 26. In the closed position (FIG. 8), the rear roof part 5 is located on the motor vehicle such that it extends over the row 6 of seats of the two-seat convertible which is shown, but which however can also be the back row of seats of a four-seat convertible.

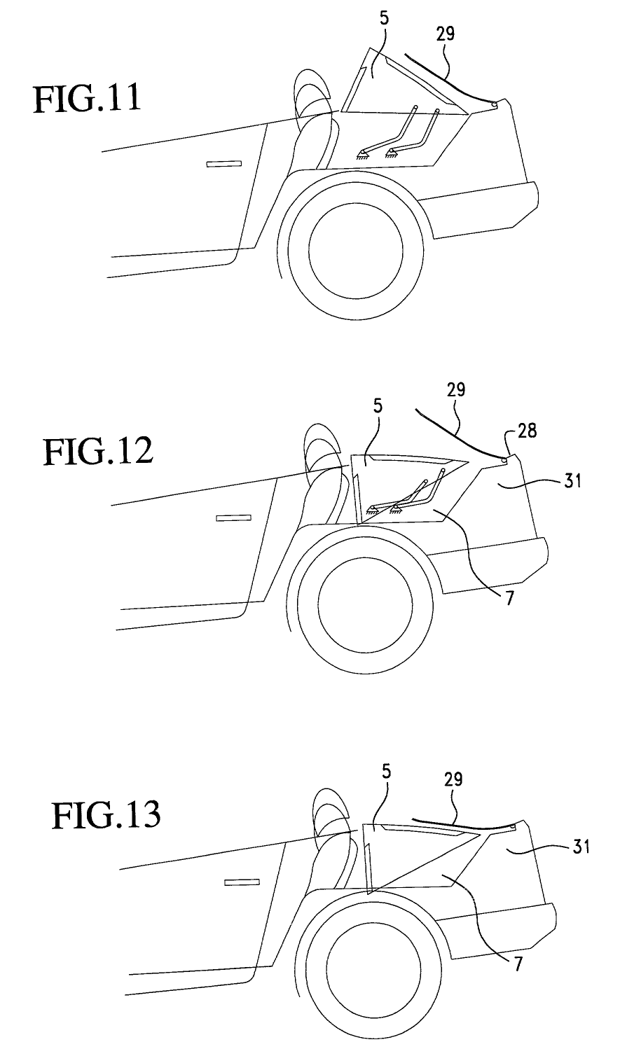

To remove the motor vehicle roof 1, the rear roof part 5 is first raised at its front edge by swiveling the four-bar mechanism 25, 26 and in doing so also moved to the rear (FIG. 10). In order to enable this backward motion, the roof storage space 7 extends farther to the rear in the direction to the back of the vehicle in comparison to the first embodiment. A resulting top opening 27 of the roof storage space 7 which extends between the rear roof part 5 (FIGS. 8 and 9) located in the closed position and the rear cover 28, for example a trunk lid or rear hatch or a fixed body part, can be closed by a roof cover flap 29 which is swivel-mounted on its rear edge 30 on the body (see FIGS. 9-12) and is swiveled up when the roof is being removed in order to allow swiveling motion of the rear roof part 5 through the opening 27. In the position of the rear roof part 5 shown in FIG. 10, the front and the middle roof part can be removed into the roof storage space 7 according to the first embodiment. Thereupon the rear roof part 5 can be lowered further (FIG. 11) until it has reached its removed position in the roof storage space 7 (FIG. 12) in which it covers the front and the middle roof part (not shown). Finally, the roof cover flap 29 is lowered again (FIG. 13) and forms a closed, continuous transition from the rear roof part 5 to the cover 28 of the trunk 31.

The convertible 2 thus also contains in this embodiment a hardtop vehicle roof 1 which can be completely opened and which is deposited in the roof storage space 7 with the roof parts positioned with the same camber. The possibilities in the configuration of the hardtop vehicle roof for two-seat and four-seat convertibles are expanded and the space-saving from the identically cambered deposition is preserved by the bearing means 24 of the rear roof part 5 which allows its displacement pointed to the rear during deposition.

I claim:

1. A motor vehicle roof for a convertible motor vehicle having an interior, comprising:
a front roof part arrangement pivotally supported on the motor vehicle by a multiple-bar arrangement;
a rear roof part which can be moved between a closed position which covers the motor vehicle interior and a removed position which exposes the motor vehicle interior in a rear roof storage space;
wherein the rear roof part is movably supported by a bearing means on the motor vehicle, said bearing means permitting movement of the rear roof part when the front roof part arrangement is being removed into an upper position, the rear roof part being capable of covering the removed front roof part arrangement in an identically pointed alignment while in a lower removed position.

2. The motor vehicle roof of claim 1, wherein the rear roof part is supported for swiveling around a rear, vehicle-mounted transverse axle.

3. The motor vehicle roof of claim 1, wherein the rear roof part is pivotally supported on the motor vehicle by a connecting rod means.

4. The motor vehicle roof of claim 1, wherein the rear roof part is positioned set back by one of the bearing means and a connecting rod means in its lower removed position in the roof storage space relative to its closed position.

5. The motor vehicle roof of claim 1, further including a rear, pivotally supported roof cover flap with a raiseable front edge, the cover flap being located behind the rear roof part in order to cover a top opening of a roof storage space.

6. The motor vehicle roof of claim 5, wherein the roof cover flap is one of a trunk lid and an additional flap supported on one of a trunk lid and the vehicle.

7. The motor vehicle roof of claims 1, wherein the front roof part arrangement contains a front roof part and a middle roof part, the front roof part capable of being moved into an identically cambered position over or under the middle roof part by means of a four-bar arrangement which is supported on the middle roof part.

8. The motor vehicle roof of claims 7, wherein the middle roof part is movably supported on the vehicle by a four-bar mechanism.

9. The motor vehicle roof of claim 7, wherein the front roof part is forcibly moved by a coupling rod connected to a bearing means of the middle roof part.

10. The motor vehicle roof of claim 9, wherein the front and the middle roof parts as well as the rear roof part each have its own drive.

11. The motor vehicle roof of claim 10, wherein said drive is a piston-cylinder drive.

12. The motor vehicle roof of claims 7, wherein the rear roof part can be positioned in a protective position as a roll bar when the front and middle roof parts have been removed.

13. The motor vehicle roof of claim 12, wherein the closed position of the rear roof part forms its protective position.

14. A convertible motor vehicle including a motor vehicle roof and an interior, comprising:
a front roof part arrangement pivotally supported on the motor vehicle by a multiple-bar arrangement;
a rear roof part which can be moved between a closed position which covers the motor vehicle interior and a removed position which exposes the motor vehicle interior in a rear roof storage space;
wherein the rear roof part is movably supported by a bearing means on the motor vehicle, said bearing means permitting movement of the rear roof part when the front roof part arrangement is being removed into an upper position, the rear roof part being capable of covering the removed front roof part arrangement in an identically pointed alignment while in a lower removed position.

15. The convertible motor vehicle of claim 14, further including a rear, pivotally supported roof cover flap with a raiseable front edge, the cover flap being located behind the rear roof part in order to cover a top opening of a roof storage space.

16. The convertible motor vehicle of claim 15, wherein the roof cover flap is one of a trunk lid and an additional flap supported on one of the trunk lid and the motor vehicle.
